(19) United States
(12) Patent Application Publication
(10) Pub. No.: US 2015/0329338 A1
(43) Pub. Date: Nov. 19, 2015

(54) STOPPER REMOVER

(71) Applicant: Daniel Charles GARABADIAN, Cumming, GA (US)

(72) Inventor: Daniel Charles GARABADIAN, Cumming, GA (US)

(21) Appl. No.: 14/812,835

(22) Filed: Jul. 29, 2015

Related U.S. Application Data
(63) Continuation-in-part of application No. 14/080,984, filed on Nov. 15, 2013.

(51) Int. Cl. B67B 7/06; B67B 7/10

(52) U.S. Cl. CPC B67B 7/063; B67B 7/10

(57) ABSTRACT

An opener for removing a stopper from a bottle includes a handle, a prong extending from the handle, and at least one barb formed on the prong for engaging the bottom of the stopper. In one form, the barb is flexible and flexes to and fro relative to the prong between a first position lying substantially coplanar with the prong and a second position extending therefrom to assist in pulling the stopper from the bottle.

### CROSS-REFERENCE TO RELATED APPLICATION

This application is a continuation-in-part of U.S. Non-Provisional patent application Ser. No. 14/080,984 filed Nov. 15, 2013, the entirety of which is hereby incorporated herein by reference for all purposes.

### BACKGROUND OF THE INVENTION

As described in U.S. Pat. No. 7,237,455 of Taylor, some bottles, such as wine bottles, have a stopper or cork-like structure to retain the bottle's contents inside the bottle. One tool used to remove stoppers from bottles is a corkscrew with a handle or lever. Another device used to remove stoppers or corks from bottles is a device commonly referred to as an “ah-so.” The ah-so has two thin, slender elements, one typically longer than the other, connected to a handle. The '455 Patent of Taylor describes a device which combines elements of the so-called “ah-so” cork remover with a more traditional corkscrew.

### SUMMARY OF THE INVENTION

Briefly described, in an example form the present invention comprises an opener for removing a stopper from a bottle. The opener includes a handle, first and second prongs extending from the handle, and at least one barb formed on at least one of the prongs for engaging the bottom of the stopper. In one form, the barb is flexible and flexes to and fro relative to the prong between a first position lying substantially coplanar with the prong and a second position extending therefrom to assist in pulling the stopper from the bottle.

Defined another way, the opener includes a handle and first and second prongs for manipulation by the handle. Each of the prongs has an inside surface and an outside surface, and they have a distal end and a proximal end nearer the handle. At least one of the prongs has a barb portion, and the prongs are adapted to be inserted between the stopper and an inner surface of the bottle. The barb portion is positioned along the inside surface of the prong, whereby the handle can be used to apply physical force to cause the prongs to be moved between the stopper and the inside surface of the bottle and the barb is adapted to be moved past the end of the stopper so that the barb can engage an underside of the stopper, and the barb is adapted so that as the handle is pulled upwardly and the prongs are extracted from the bottle, the prongs and the barb pull on the stopper to remove the stopper from the bottle.

Optionally, each of the prongs includes a barb portion. Preferably, the barb portion is movable relative to the prong so as to move in a first direction out of the way as the prong is inserted between the bottle and the stopper and to move in a second direction, opposite to the first direction, as the barb portion moves past a bottom end of the stopper.

In a preferred form, the prongs are flat, elongate strip-like elements and the barbs are formed integrally with the prongs.

Optionally, the prongs are rigidly secured to the handle and are moved in unison therewith. Alternatively, the handle comprises a pair of handle portions and one handle portion can be moved relative to the other and the prongs are separately insertable into the bottle between the bottle and the stopper one at a time.

In an alternative form, the prongs are wire-like elements with barbs that generally face toward each other. Optionally, these barbs are substantially rigid relative to the prongs. Alternatively, the barbs can fold out of the way as the prongs are inserted into the bottle and between the bottle and the stopper and can unfold once the barbs clear the bottom of the stopper for engaging and pulling on the bottom of the stopper as the prongs are pulled upwardly for removing the stopper.

Optionally, the prongs are much longer than they are wide and are much wider than they are thick and they each have a barb.

According to another example form, the present invention relates to an opener for removing a stopper from a bottle. The opener includes a handle and a prong. The prong extends from the handle and includes a proximal end mounted to the handle, at least indirectly, and a distal end generally opposite the proximal end. The distal end includes a head having at least one tab extending therefrom. The prong is adapted to be inserted between the stopper and an inner surface of the bottle. The tab is positioned along an inside surface of the prong, whereby the handle can be used to apply physical force to cause the prong to be moved between the stopper and the inside surface of the bottle. The tab is adapted to be moved past the end of the stopper so that the tab can engage an underside of the stopper. In example forms, the tab is adapted so that as the handle is pulled upwardly and the prong is extracted from the bottle, the prong and the tab pull on the bottom of the stopper to remove the stopper from the bottle.

According to yet another form, the present invention relates to a stopper remover for removing a stopper from a bottle. The stopper remover includes an elongate prong and a handle. The elongate prong includes an inside surface and an outside surface, a distal end and a proximal end, and at least one tab nearer to the distal end than to the proximal end. The prong is adapted to be inserted between the stopper and an inner surface of the bottle and wherein the at least one tab protrudes beyond an inner surface of the prong. The handle is adapted to be grasped and is connected or coupled to the prong so that the handle can be used to apply physical force to cause the prong to be moved between the stopper and the inside surface of the bottle. The tab is adapted to be moved past the end of the stopper so that the tab can engage an underside of the stopper. Further, the tab is adapted so that as the handle is pulled upwardly and the prong is extracted from the bottle, the prong and the tab pull on the stopper to remove the stopper from the bottle.

### BRIEF DESCRIPTION OF THE DRAWING FIGURES

FIG. 1 is a perspective view of a stopper remover according to an example embodiment of the present invention.

FIG. 2 is a side sectional view of the stopper remover of FIG. 1, showing the remover inserted within a bottle wherein the barbs of the prongs are engaged with the bottom of the stopper.

FIG. 2A is a detailed view of a portion of the stopper remover of FIG. 2, showing the barb of the prong engaged with the bottom of the stopper.

FIG. 3 is a front elevation view of a stopper remover according to another example embodiment of the present invention.

FIG. 3A is a detailed view of a prong portion of the stopper remover of FIG. 3, showing an end of the prong having a substantially rigid barb formed thereon.

FIG. 3B is a detailed view of a prong portion of the stopper remover of FIG. 3 according to an alternative example embodiment of the present invention, showing the prong having a substantially rigid barb formed thereon.

FIG. 4A is a perspective view of a stopper remover according to another example embodiment of the present invention.

FIG. 4B is a perspective view of the stopper remover of FIG. 4A, showing the handle comprising a pair of handle portions wherein one handle is movable relative to the other such that the prongs can be separately insertable into the bottle between the bottle and the stopper one at a time.

FIG. 5 is a front elevation view of a stopper remover according to another example embodiment of the present invention.

FIG. 6 is a top, partial cross-sectional view of a stopper remover in use with a bottle and a stopper, wherein a pair of barbs are insertable between the bottle and the stopper, and wherein the barbs are rotatable to engage the bottom end of the stopper.

FIG. 7 is a perspective view of a stopper remover according to another example embodiment of the present invention.

FIGS. 8A-C are perspective, front elevation, and bottom views of a prong for the stopper remover of FIG. 7.

FIGS. 9A-C are several views of a prong for use with a stopper remover according to another example embodiment of the present invention, and showing a process for the manufacture thereof.

FIG. 10 is a perspective view of a prong for use with a stopper remover according to another example embodiment of the present invention.

FIG. 11 is a perspective view of a prong according to another example embodiment of the present invention.

FIG. 12 is a front elevation view of a prong according to another example embodiment of the present invention.

FIG. 13 is a front elevation view of a prong according to another example embodiment of the present invention.

### DETAILED DESCRIPTION OF EXAMPLE EMBODIMENTS

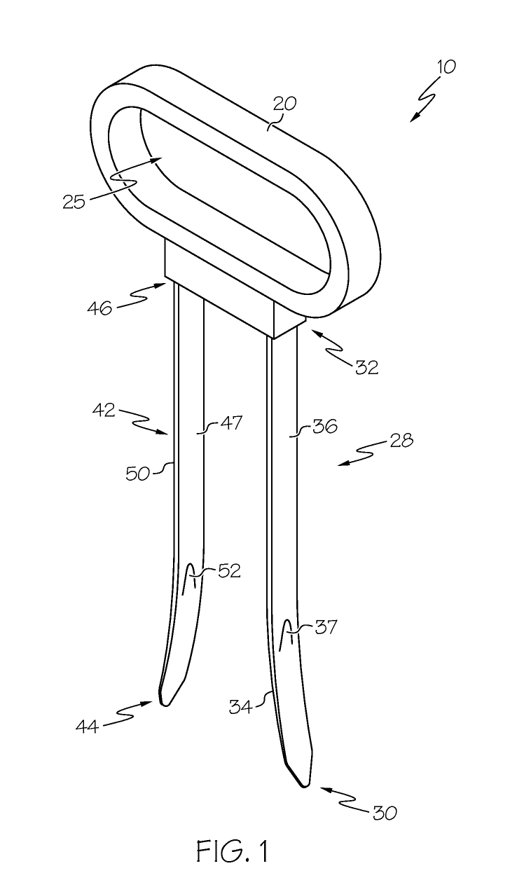

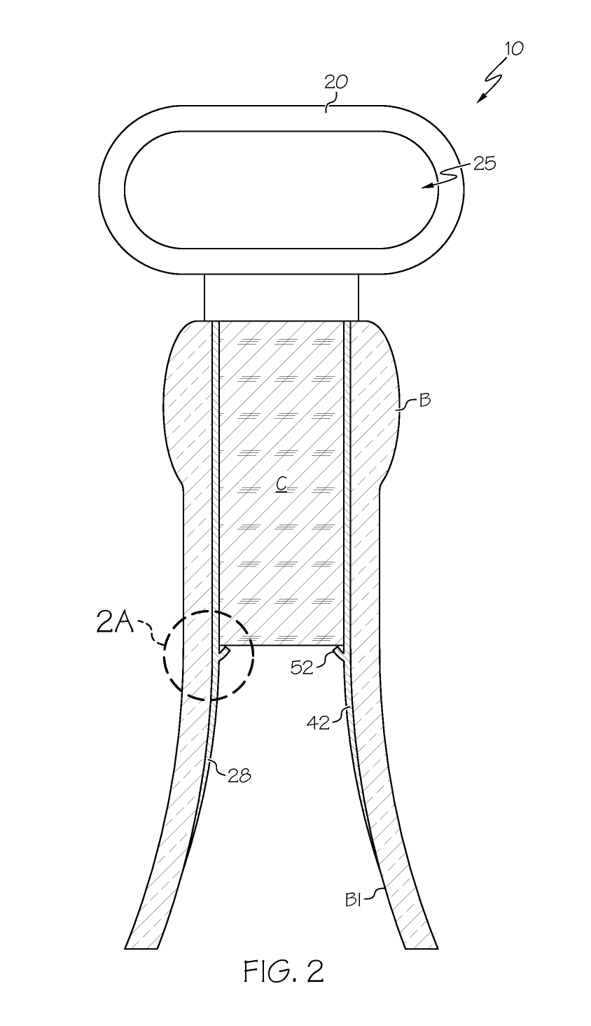

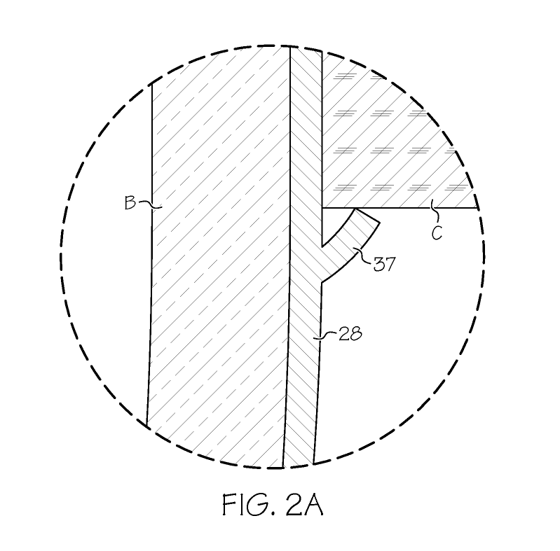

With reference now to the drawing figures, wherein like reference numbers represent corresponding parts throughout the several views, FIGS. 1-2A show a stopper remover 10 according to a first example embodiment of the present invention. The stopper remover 10 is preferably provided for removing a stopper C from a bottle B, for example, for removing a cork from a wine bottle. Optionally, the stopper remover 10 can be utilized with other containers in which a stopper is provided for sealing the container. Those skilled in the art will appreciate that the stopper remover 10 can be used in conjunction with a wide variety of stoppers. For example, the stopper C can be a natural cork stopper or a synthetic (polymer) stopper. Likewise, the container or bottle B can take many forms as well.

In example forms, the stopper remover 10 generally comprises a loop-shaped handle 20, first and second prongs 28, 42 extending from the handle 20, and wherein at least one barb 37 is formed on at least one of the prongs 28, 42. Preferably, as will be described below, the at least one barb 37 is configured for engaging the bottom end of the stopper C such that the prongs 28, 42 and the at least one barb 37 cooperate to help remove the stopper C from the bottle B.

The handle 20 is generally orientated substantially transversely relative to the prongs 28, 42 and defines an opening 25 therein for receiving one or more fingers of the user. For example, when operating the stopper remover 10, the user grasps the handle and generally one or more fingers of the user extend through the opening 25. Optionally, the handle 20 can be substantially solid (e.g., without an opening) such that a user's fingers are wrapped around the handle 20. In this latter example, the handle can be more or less rod-like to facilitate a wrap-around grip by the user.

The first and second prongs 28, 42 are generally flat, elongate strip-like elements that extend from the handle 20 at their proximal ends 32, 46 to their distal ends 30, 44. In some example forms, the prongs 28, 42 are generally much longer than they are wide and much wider than they are thick. In one example form, the first prong 28 has a length of about three and one-half inches and the second prong 42 has a length of about two and three-quarters inches, for example to facilitate insertion into the bottle B (between the inner surface BI of the bottle B and the stopper C). Optionally, the prongs 28, 42 may be of other lengths as desired. In example forms, the prongs 28, 42 are generally laterally offset and substantially parallel to one another near the proximal ends 32, 46 and gradually curve outwardly toward the distal ends 30, 44. Thus, the curvature of the prongs 28, 42 near the distal ends 30, 44 is such that outer surfaces 36, 50 of the prongs 28, 42 are typically somewhat convex-shaped, whereas inner surfaces 34, 47 of the prongs 28, 42 are typically concave-shaped. For example, in one example form as depicted in FIG. 2, the prongs 28, 42 comprising the convex and concave curvature provide for the prongs 28, 42 being generally concentric to an inside surface BI of the bottle B. In one form, the prongs 28, 42 are fixedly mounted to the handle 20, for example by welding, heat bonding, adhesive, etc. In other forms, the prongs 28, 42 are removably coupled to the handle 20, for example with screws, bolts, other fasteners, coupling mechanisms, and/or other fastening elements or mechanisms.

Barb 37 preferably is formed on the prong 28 generally near the distal end 30 thereof. Preferably, barb 37 is positioned along the prong 28 such that the barb 37 is free to engage the bottom or underside of the stopper C when the prong is inserted between the stopper and the inner surface BI of the bottle B. In one example form, the barb 37 is generally tongue-shaped and integrally formed with the prong 28 to be movable between a first position in a first direction and a second position in a second direction. Optionally, this movement is accomplished by a to and fro flexing of the tongue-shaped barbs.

In one form, a portion of the prong adjacent the barb 37 is slightly bent such that when the prong is in a relaxed position, the barb 37 protrudes inwardly beyond the inner surface 34 of the prong 28 (e.g., the second position). For example, as depicted in FIG. 2, the prong 28 is in the second position wherein the barb 37 protrudes inwardly beyond the inner surface 34 of the prong 28 and engages the underside of the stopper C. In another form, rather than bending the prong 28 to provide for the inward protrusion of the barb 37, the barb 37 itself is bent inwardly to project beyond the inner surface 34 of the prong 28. Preferably, in either case, the inwardly protruding barb 37 is substantially resilient so that when there is no force acting against the barb 37, the barb 37 protrudes inwardly beyond the inner surface 34 of the prong 28, for example, behaving similarly to a spring or other resilient member.

Optionally, the second prong 42 can include a barb 52 that is substantially similar to the barb 37. Generally, the barbs 37, 52 are positioned along the prongs 28, 42 at a substantially similar distance measured from the proximal ends 32, 46 of the prongs 28, 42. Optionally, the barbs 37, 52 can be positioned at different lengths, for example to accommodate for stoppers C of different lengths. Thus, in some forms, the barbs 37, 52 are positioned at different lengths on the prongs 28, 42 such that the stopper remover 10 is operable with stoppers C of different lengths.

In use, the distal end 30 of the first prong 28 is inserted between the stopper C and the inner surface BI of the bottle B, and with the user applying a physical force to the handle 20, the first prong 28 begins to move downwardly between the stopper C and inner surface BI. Eventually, after enough downward movement of the first prong 28, the second prong 42 is inserted between the stopper C and the inner surface BI, and then both the first and second prongs 28, 42 move downwardly together within the bottle B. As the prongs 28, 42 continue moving downwards, the barbs 37, 52 each engage the stopper C where they are forced to move laterally or flex relative to the prongs 28, 42 in the first direction to the first position. While the barbs 37, 52 remain in the first position, the prongs 28, 42 continue moving downwards until the proximal ends 32, 46 of the prongs 28, 42 generally abut the top of the bottle. As this point, the prongs 28, 42 have moved a substantial amount within the bottle (between the stopper C and the inner surface BI) such that the barbs 37, 52 have moved past the bottom end of the stopper C (no longer engaged with the stopper C).

Once the barbs 37, 52 are no longer contacting the stopper C, the barbs 37, 52 move (flex) in a second direction from the first position to the second position (see FIGS. 2-2A). With the barbs 37, 52 now inwardly extending beyond the inner surfaces 34, 47 of the prongs 28, 42, the stopper C can be removed from the bottle B. A physical force is then applied to the handle 20 in an upwards direction while generally twisting the handle to begin removing the stopper C. And since the barbs 37, 52 are in the first position, the prongs 28, 42 and the barbs 37, 52 pull on the stopper C to remove the stopper C from the bottle B.

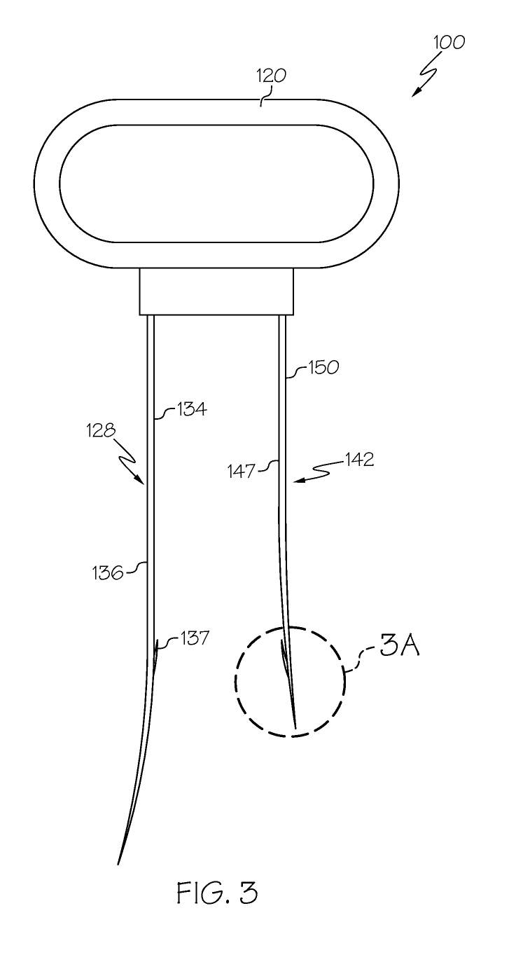

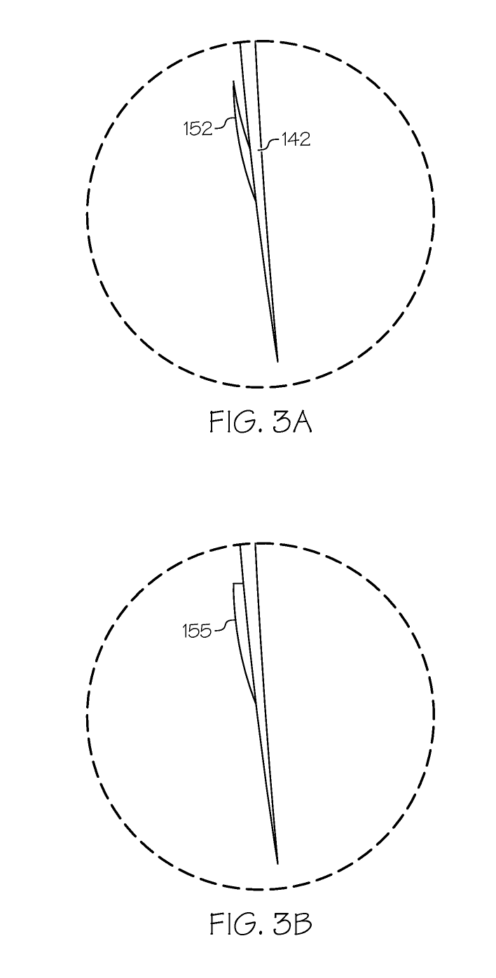

FIGS. 3-3A show a stopper remover 100 according to another example embodiment of the present invention. Generally, the stopper remover 100 is similar to the stopper remover 10, and comprises a handle 120, a first prong 128, a second prong 142, and at least one barb 137. Optionally, the stopper remover 100 comprises two barbs 137, 152. Preferably, the barbs 137, 152 are substantially rigid relative to the prongs 128, 142 and comprise a fin-like member formed on the inner surfaces 134, 147 of the prongs 128, 142. In one example form as depicted in FIG. 3A, the barb 152 tapers outwardly from the bottom end to a tip-like top end. Optionally, for example, as depicted in FIG. 3B, a barb 155 is provided such that it tapers outwardly from the bottom end to a flat-like top end. Optionally, barbs of other shapes can be provided as desired.

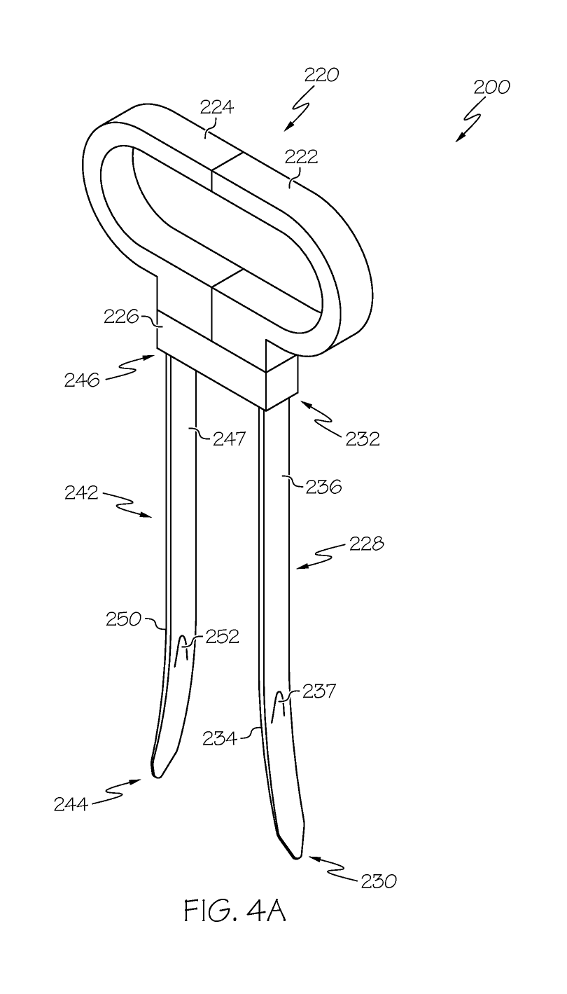

FIGS. 4A-B show a stopper remover 200 according to another example embodiment of the present invention. Generally, the stopper remover 200 is similar to the stopper remover 10, and comprises a handle 220, a first prong 228, a second prong 242, and at least one barb 237. Preferably, the handle 220 comprises a pair of handle portions 222, 224 wherein one handle portion can be moved relative to the other handle portion, and thus one prong is movable relative to the other prong. As depicted in FIG. 4B, the first handle portion 222 is rigidly mounted to a base 226, which comprises the first prong 228 rigidly mounted thereto and extending therefrom. The second handle portion 224 comprises the second prong 242 extending therefrom, which is insertable within an opening of the base 226 such that the second handle portion 224 (and prong 242 extending therefrom) can move relative to the first handle portion 222 (and first prong 228 extending therefrom). Preferably, the ability to move the second handle portion 224 and second prong 242 facilitates separately inserting the prongs 228, 242 one at a time into the bottle B between the inner surface BI and the stopper C. In one example form, each prong comprises a barb 237, 252, and after inserting the first prong 228 into the bottle, the barb 237 engages the underside of the stopper C to prevent any downwards movement of the stopper C while the second prong 242 is inserted therein. As depicted, the barbs 237, 252 are positioned at different lengths along their respective prongs 228, 242. Optionally, the barbs 237, 252 can be positioned at substantially equal lengths.

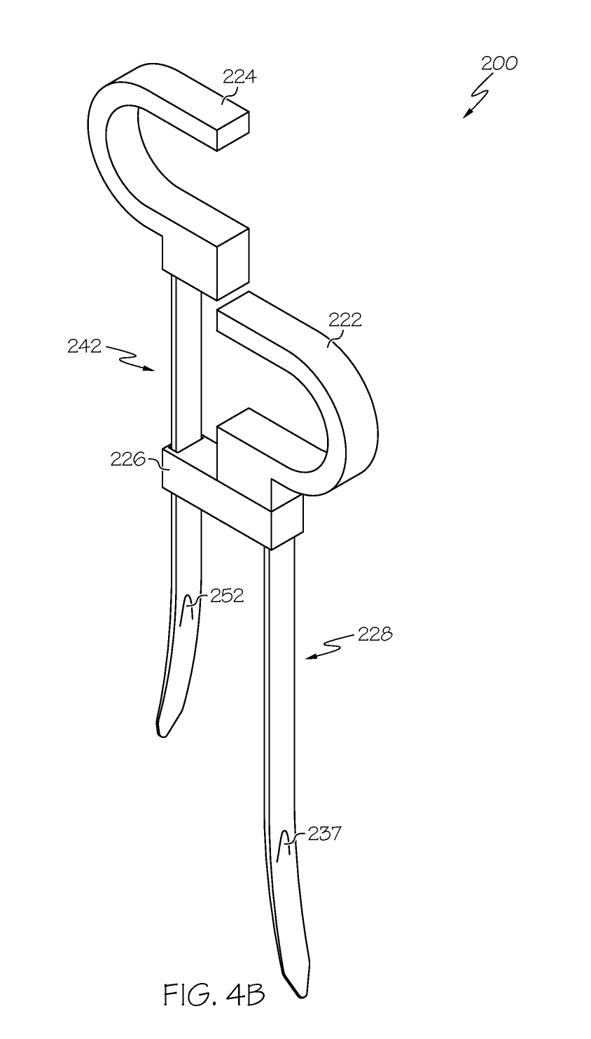

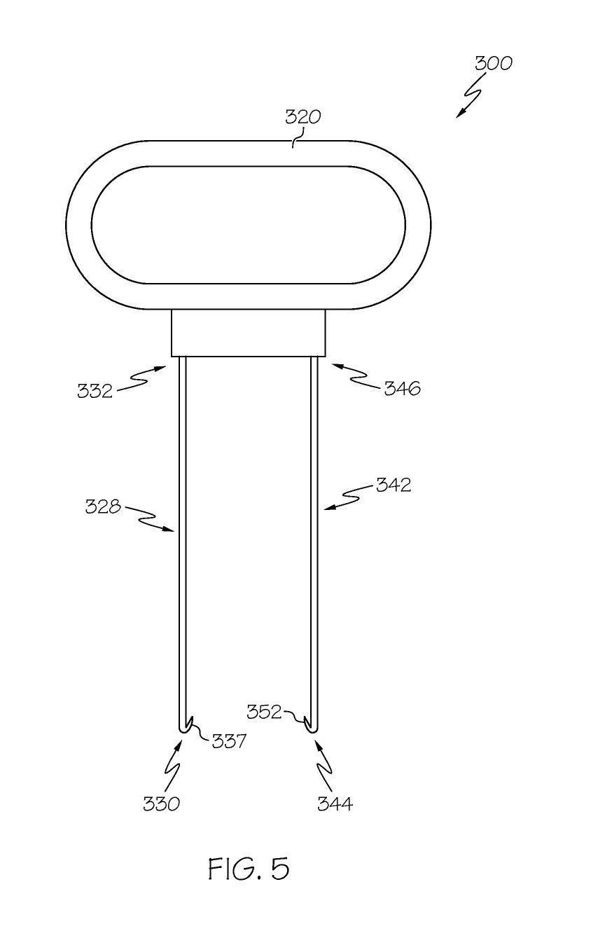

FIG. 5 shows a stopper remover 300 according to yet another example embodiment of the present invention. Generally, the stopper remover 300 comprises a handle 320 and a pair of wire-like prongs 328, 342. In one form, the prongs 328, 342 are generally slim or wire-like and extend from their mounted proximal ends 332, 346 to their free distal ends 330, 344. Preferably, the distal ends 330, 344 each comprise a barb 337, 352 that face each other. In one form, the barbs 337, 352 are integrally formed with the distal ends 330, 344 of the prongs 328, 342 and generally face each other. Optionally, the barbs 337, 352 are fixedly or removably mounted thereto and can be oriented as desired. Preferably, the prongs 328, 342 comprise a substantially similar length such that the barbs 337, 352 can act in unison to remove the stopper C from the bottle B when applying an upwards physical force to the handle 320. Optionally, the prongs 328, 342 may each have a desired length. Preferably, in some example forms, the wire-like prongs 328, 342 are formed from a substantially rigid material, for example, stainless steel, titanium, or other materials.

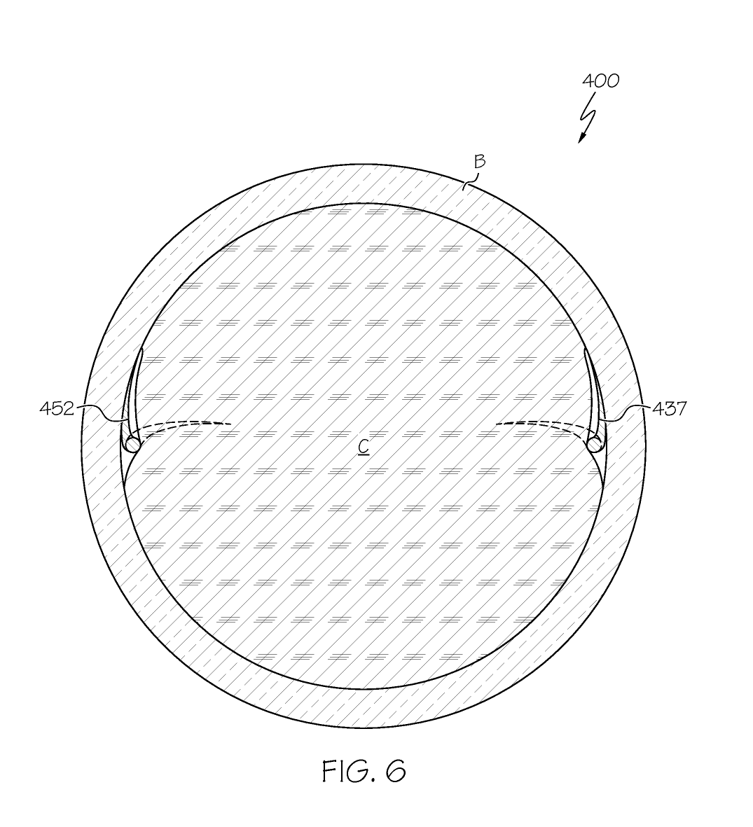

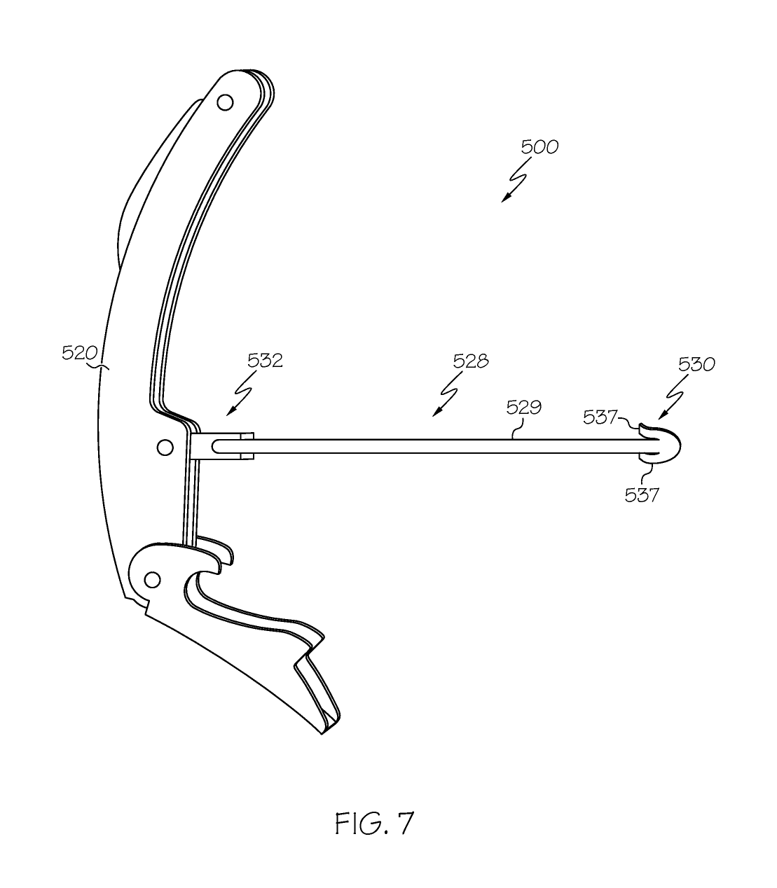

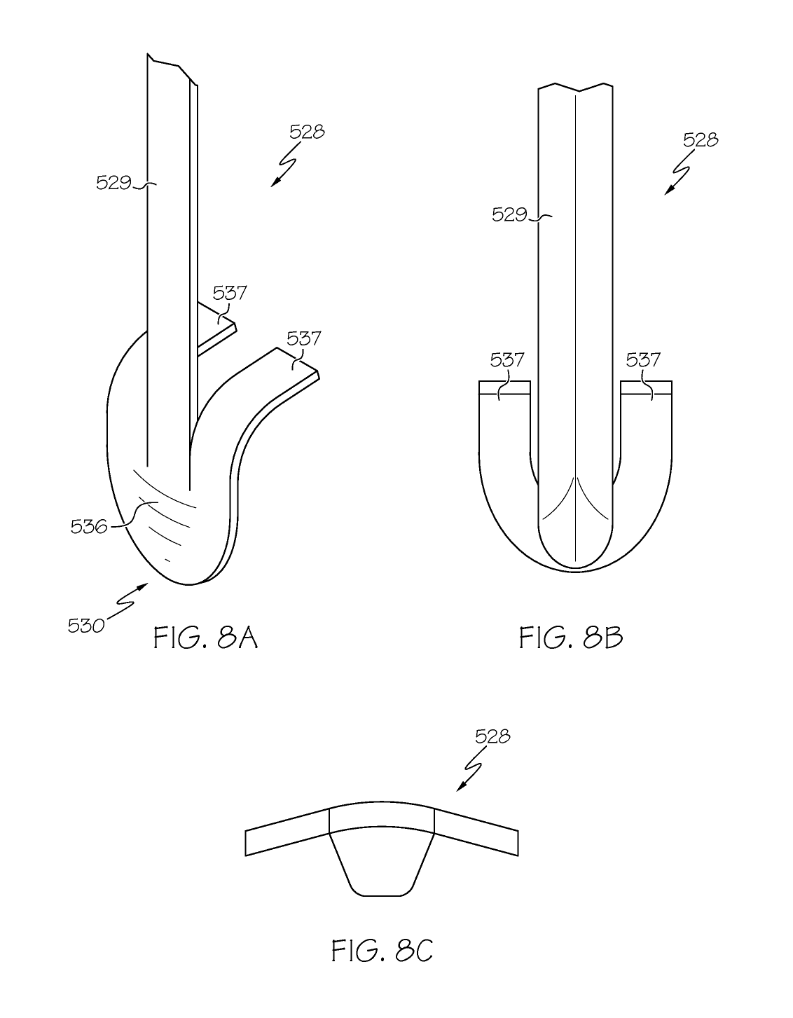

FIG. 6 shows a portion of a stopper remover 400 according to another example embodiment of the present invention. As depicted, the stopper remover comprises a pair of transversely extending claw-like barbs 437, 452, which are shaped to comprise an outer contour that is substantially similar to the inner contour of the inner surface BI of the bottle B. As such, the barbs 437, 452 are preferably inserted between the inner surface of the bottle B and the stopper C and forced downwards until the barbs 437, 452 pass the bottom side of the stopper C. Preferably, as described above, the barbs 437, 452 each comprise prongs (unshown) extending therefrom to a pair of handle portions. After the barbs have moved downwards enough to be positioned below the bottom of the stopper C, the handle portions are rotated to cause the barbs 437, 452 to project under the bottom of the stopper C (see phantom lines). Then, any upwards force of the handle will cause the barbs 437, 452 to engage the bottom of the stopper C and facilitate in removing the same therefrom.

FIG. 7 shows a stopper remover 500 according to another example embodiment of the present invention. As depicted, the stopper remover 500 generally comprises a main body portion or handle 520 and a plurality of components pivotally attached to the handle 520. According to one form, a generally elongate prong 528 foldably extends from the handle 520 at its proximal end 532 to its distal end 530. The proximal end 532 is pivotably attached to the handle 500 at pivot pin 525. The prong 528 is generally formed from a substantially rigid and elongate member 529, which is preferably formed from a metal (e.g., steel, aluminum, etc.) and comprises an inner surface and an outer surface. Optionally, other materials can be used, including composites, plastics, or other materials. In some example forms, the member 529 is formed from annealed steel and may be tempered. In example forms and as depicted, in addition to the prong 528, the handle 520 includes a knife or trimming blade and a bottle opener pivotally mounted thereto. Optionally, other components as desired may be combined with the presently claimed invention.

A pair of barbs or tabs 537 are formed at the distal end 530 of the prong 528, which are generally bent or curved relative to the elongate member 529. In example forms, the tabs 537 protrude inwardly beyond the inner surface (e.g., generally away from the outer surface). As similarly described above, the tabs 537 are provided for projecting and/or extending under the bottom of the stopper C such that any upward force of the handle will cause the tabs 537 to engage the bottom of the stopper C and facilitate removing the same from the bottle B.

FIGS. 8A-C show the prong 528 and tabs 537 thereof in greater detail. In example forms, the distal end 530 of the prong 528 generally comprises a tongue-shaped portion, head or barb portion 536, which is generally radiused or curved to provide for insertion between the bottle B and the stopper C. The tabs 537 generally extend from a portion of the head 536 and curve in a direction generally perpendicular relative to the head 536. Optionally, the tabs 537 can extend at an angle relative to the head 536, for example, at an acute or obtuse angle relative thereto. The extension of the tabs 537 can preferably be adjusted as desired, for example, to provide a sufficient amount of extension to interfere with the bottom of the stopper C, but not too much extension to prevent the prong 528 from moving between the bottle B and the stopper C. Preferably, the tabs 537 are substantially rigid, yet at least partially resiliently flexible, such that they are capable of moving (slipping) between the bottle B and the stopper C, and wherein once passing the bottom of the stopper C, they return to their curved, un-flexed state to allow for engagement with the bottom of the stopper C.

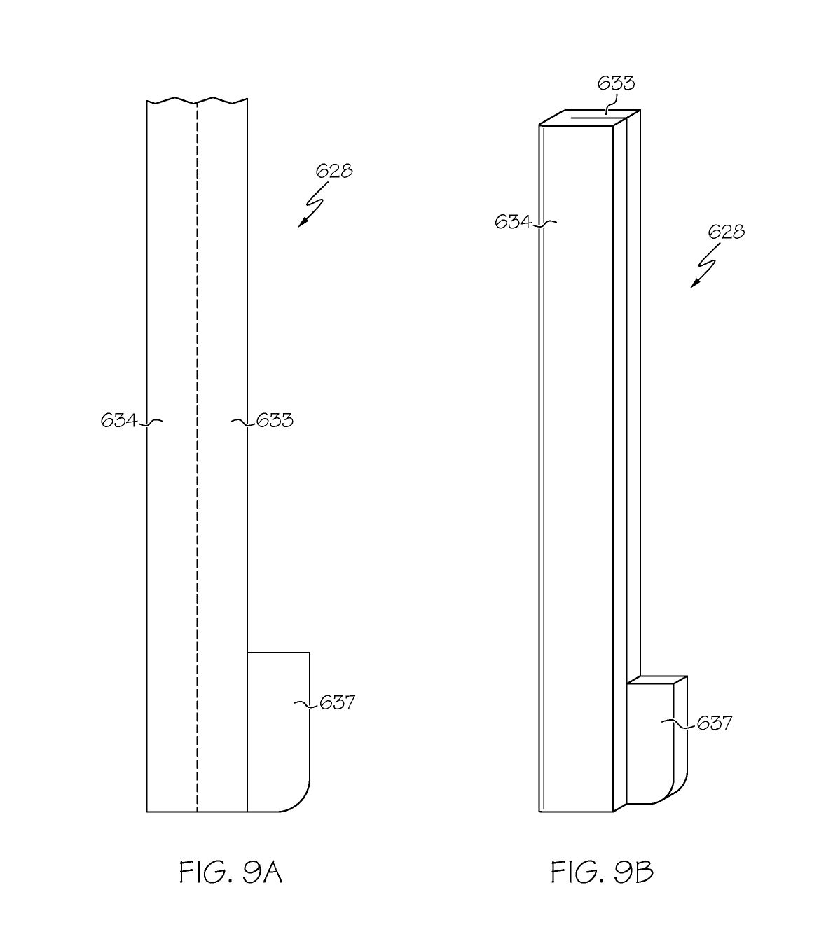

FIGS. 9A-C show a prong 628 according to another example embodiment of the present invention. In example forms, the prong 628 can be used with the handle 520 as described above, and can be pivotally mounted with the handle 520 as similarly described above. As shown in FIG. 9A, the prong 628 generally comprises an elongate and generally flat member comprising a first side 633, a second side 634, and a tab 637 formed along the distal end thereof. As shown in FIG. 9B, the sides 633, 634 are generally folded relative to one another, and as shown in FIG. 9C, an end of the tab 637 is generally bent to curve in a direction substantially perpendicular to the extension of the folded sides 633, 634. Preferably, the prong 628 and tab 637 thereof are configured for moving between the bottle B and stopper C such that the tab 637 can engage the bottom of the stopper C for removing the stopper C from the bottle B. As similarly described above, the tab 637 is generally rigid yet at least partially resiliently flexible.

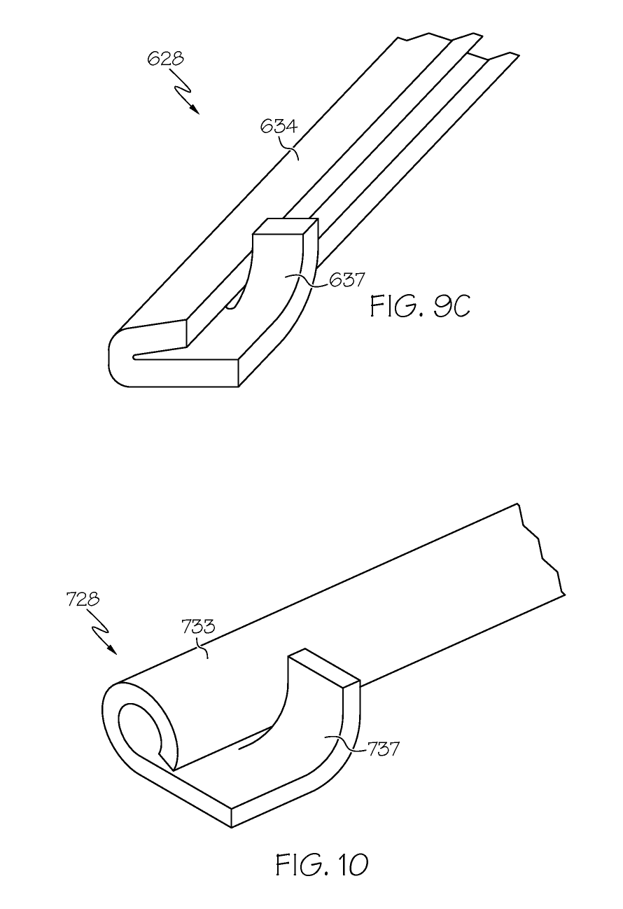

FIG. 10 shows a prong 728 according to another example embodiment of the present invention. As depicted, the prong 728 is substantially similar to the prong 628 as described above. Preferably, rather than comprising two sides that are generally folded relative to one another, a body 733 thereof is generally rolled to form at least a small generally radial opening extending along the length of the prong 728. Thus, in example forms, the body 733 is generally rolled in a direction substantially perpendicular relative to the extension of the prong 728. Similarly, the tab 737 is bent or curved to generally extend in a direction perpendicular relative to the extension of the body 733 of the prong 728.

In example embodiments, the stopper removers (and handles, prong(s), barbs or tab(s)) of the present invention can be constructed from a variety of materials including metals, plastics, composites, synthetic materials, natural materials, other materials and/or combinations thereof. In one example form, the handle is formed from aluminum and the prongs are formed from stainless steel. Preferably, in some embodiments, the prongs are constructed from a material that allows for the at least one barb to move relative to the prong between the first position and the second position. Optionally, according to some example forms, the prong(s) are formed from annealed steel and the tab(s) thereof are tempered. Optionally, one or more features or elements as described herein may be welded or laminated together as desired, for example, instead of providing a unitary, integrally formed piece. According to some example forms, the thickness of the one or more prongs is between about 0.01 inches to about 0.025 inches, more preferably between about 0.01 inches to about 0.012 inches. In example forms, a balance may be found between the rigidity, flexibility, and resiliency of portions of the prong(s) such that there is enough rigidity in the elongate member to support and withstand the pushing and pulling force required to force the barbs or tabs below the cork between the cork and the bottle, and for pulling the cork out of the bottle. Similarly, there should be enough flexibility and resiliency in the barbs so that the bending action that occurs when inserting the prong(s) between the bottle and cork does not cause fatigue failure over time.

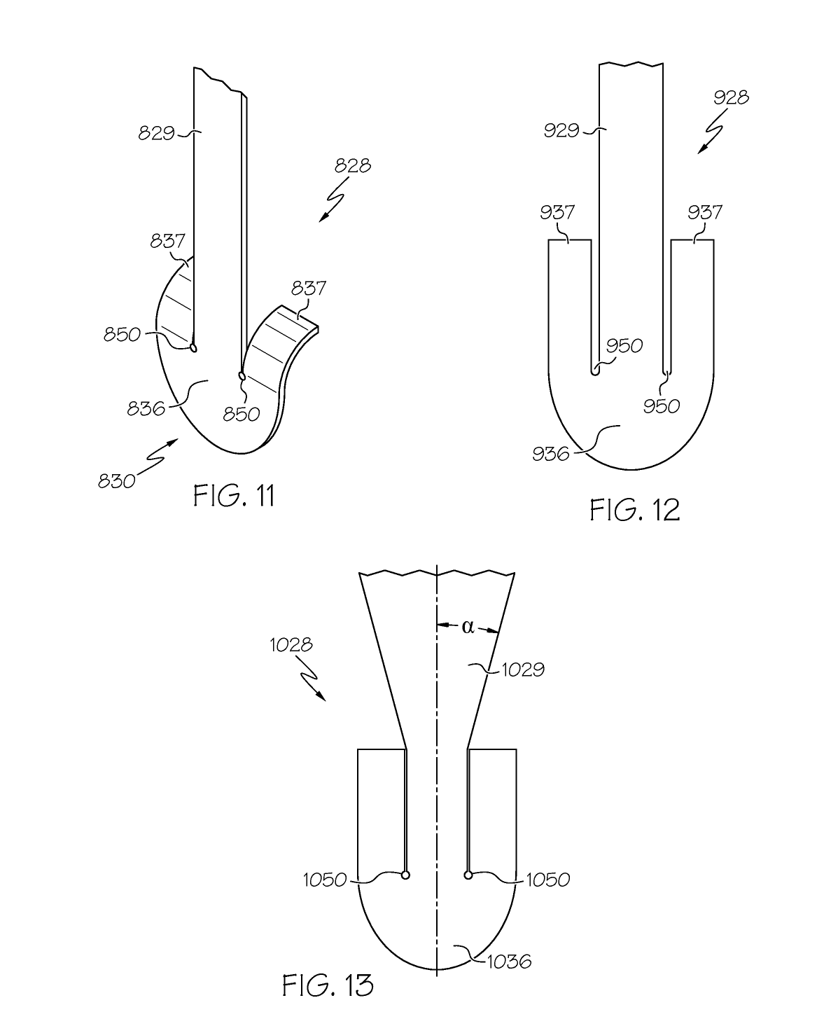

In additional example embodiments, the presently claimed invention can comprise one or more radiused portions for eliminating any stress risers or chances of inducing one or more fatigue cracks at the end of the miniscule gaps defined between the elongate member 529 and the tabs 537. As depicted in FIG. 11, a prong 828 comprises two openings 850 for substantially reducing fatigue failure of the tabs 837 over time. According to one manufacturing method, one or more stamp patterns are provided on a metal cutting press machine and a sheet of metal is provided for being stamped by the patterned template on the press machine. Thus, the location of the openings is where the end of a portion of the stamp extended through the metal to create a miniscule gap or no gap at all. In some forms, the opening is provided in the patterned template. Optionally, holes are drilled at the desired location before or after stamping. Optionally, a hole or radoused portion is provided for the tab shown in FIGS. 9A-10.

As depicted in FIG. 12, the prong 928 is in its configuration prior to bending the tabs thereof. The prong 928 comprises two pockets 950 formed on sides of the elongate member 929 and the tabs 937. According to another example form (see FIG. 13), the prong comprises a drafted elongate member 1029, which generally forms a narrower width at the distal end 1030 and a larger width at the proximal end 1032. In example forms, the angle α can be between about 5 degrees to about 90 degrees, more preferably between about 5 degrees to about 16 degrees. Optionally, the elongate member 1029 may be shaped as desired. Optionally, one or more openings 1050 are provided for substantially eliminating the stress risers. In example forms, the openings 1050 extend through the entirety of the prong 1028 and are generally cylindrical in shape. Optionally, other shapes, including other radiuses, sizes etc. or other shapes and configurations may be used as desired.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. An opener for removing a stopper from a bottle, the opener comprising:
a handle; and
at least one prong extending from the handle, the prong comprising a proximal end mounted to the handle and a distal end generally opposite the proximal end, the distal end comprising a head having at least one tab extending therefrom, wherein the prong is adapted to be inserted between the stopper and an inner surface of the bottle and wherein the tab is positioned along an inside surface of the prong, whereby the handle can be used to apply physical force to cause the prong to be moved between the stopper and the inside surface of the bottle and the tab is adapted to be moved past the end of the stopper so that the tab can engage an underside of the stopper, and the tab is adapted so that as the handle is pulled upwardly and the prong is extracted from the bottle, the prong and the tab pull on the stopper to remove the stopper from the bottle.

2. The opener of claim 1, wherein the at least one tab is movable relative to the prong so as to move in a first direction out of the way as the prong is inserted between the bottle and the stopper and to move in a second direction, opposite to the first direction, as the barb portion moves past a bottom end of the stopper.

3. The opener of claim 2, wherein the prongs are flat, elongate strip-like elements and the at least one tab is formed integrally with the prongs.

4. The opener of claim 2, wherein the prong is pivotally mounted to the handle.

5. The opener of claim 2, wherein the at least one tab is substantially rigid relative to the prongs.

6. The opener of claim 2, wherein prong is much longer than it is wide and is much wider than it is thick.

7. The opener of claim 5, wherein at least one tab is positioned generally near the distal end of the prong.

8. The opener of claim 5, wherein the at least one tab can fold out of the way as the prong is inserted into the bottle and between the bottle and the stopper and can unfold once the at least one tab clears the bottom of the stopper for engaging and pulling on the bottom of the stopper as the prong is pulled upwardly for removing the stopper.

9. The bottle opener of claim 1, wherein prong comprises a tongue-shaped head integrally formed at the distal end of the prong, and wherein the tongue-shaped head comprises two curved tabs extending therefrom in a direction generally perpendicular relative to the prong.

10. The bottle opener of claim 1, wherein the prong is generally rolled in a direction substantially perpendicular relative to the extension of the prong and forms at least a small generally radial opening extending along the length of the prong.

11. A stopper remover for removing a stopper from a bottle, the stopper remover comprising:
an elongate prong having an inside surface and an outside surface, a distal end and a proximal end, and at least one tab nearer the distal end than the proximal end, wherein the prong is adapted to be inserted between the stopper and an inner surface of the bottle and wherein the at least one tab protrudes beyond an inner surface of the prong; and
a handle adapted to be grasped and connected to the prong whereby the handle can be used to apply physical force to cause the prong to be moved between the stopper and the inside surface of the bottle, and wherein the tab is adapted to be moved past the end of the stopper so that the tab can engage an underside of the stopper, and the tab is adapted so that as the handle is pulled upwardly and the prong is extracted from the bottle, the prong and the tab pull on the stopper to remove the stopper from the bottle.

12. The stopper remover of claim 11, wherein the distal end of the prong comprises a tongue-shaped portion, and wherein at least one tab extends from the tongue-shaped portion.

13. The stopper remover of claim 12, wherein the tongue-shaped portion comprises two tabs extending therefrom.

14. The stopper remover of claim 11, wherein the tab is integrally formed with the prong and can flex to and fro such that as the prong is inserted between the stopper and the bottle, the tab flexes to lie in close relation to the prong and wherein as the prong is fully inserted the tab clears an end of the stopper and flexes to lie under the end of the stopper.

15. The stopper remover of claim 12, wherein the barb is flexible and flexes to and fro relative to the prong between a first position lying substantially coplanar with the tongue-shaped portion and a second position extending therefrom to assist in pulling the stopper from the bottle.

16. The stopper remover of claim 11, wherein the at least one tab generally extends from the prong such that it is generally perpendicular relative thereto.

17. The stopper remover of claim 16, wherein the tab is generally curved relative to the prong.

18. The stopper remover of claim 11, wherein the prong is generally rolled in a direction substantially perpendicular relative to the extension of the prong and forms at least a small generally radial opening extending along the length of the prong.

19. The stopper remover of claim 11, further comprising one or more openings or pockets formed at the intersection of the at least one tab and the elongate prong.
